(19) United States
(12) Patent Application Publication
(10) Pub. No.: US 2012/0284674 A1
(43) Pub. Date: Nov. 8, 2012

(54) TOUCH CONTROL METHOD AND APPARATUS

(75) Inventors: Liang Geng, Beijing (CN); Heng Liu, Beijing (CN); Hui Li, Beijing (CN); Lei Guo, Shenzhen (CN); Wenbin Hu, Shenzhen (CN); Kang Zhong, Shenzhen (CN); Yao Yu, Shenzhen (CN)

(73) Assignee: Huawei Device Co.,Ltd., Shenzhen (CN)

(21) Appl. No.: 13/552,452

(22) Filed: Jul. 18, 2012

Related U.S. Application Data
(63) Continuation of application No. PCT/CN2010/078859, filed on Nov. 18, 2010.

(30) Foreign Application Priority Data
Jan. 18, 2010 (CN) 201010004045.8

(51) Int. Cl. G06F 3/041; G09G 5/34; G06F 3/048

(52) U.S. Cl. 715/863; 345/173; 345/650; 178/18.01

(57) ABSTRACT

Embodiments of the present disclosure disclose a touch control method and an apparatus. The method includes: entering, when it is detected that a user triggers a function control, a function state corresponding to the function control; detecting a touch control operation performed by the user on an operation object on a touch control panel; under the function state corresponding to the function control, performing corresponding processing on the operation object according to the touch control operation of the user.

This application is a continuation of International Application No. PCT/CN2010/078859, filed on Nov. 18, 2010, which claims priority to Chinese Patent Application No. 201010004045.8, filed with the Chinese Patent Office on Jan. 18, 2010, and entitled “TOUCH CONTROL METHOD AND APPARATUS”, which is incorporated herein by reference in its entirety.

### FIELD

The present disclosure relates to the field of touch control technologies, and in particular, to a touch control method and apparatus.

### BACKGROUND

In man-machine interaction technologies, a touch control technology has a wide application, for example, an electric device such as a touch mobile phone and a touch computer. The man-machine interaction is able to be well implemented by using the touch control technology. The electric device using the touch control technology receives input information from a screen through a touch screen or a touch control panel, thereby providing a more visual and more convenient operation experience for a user.

The touch control technology in the prior art is mostly single-point touch control, that is, supporting the user to use a finger to perform a touch control operation, for example, clicking and dragging.

A multi-point touch control technology in the prior art allows the user to use multiple fingers to perform touch control, so as to implement a better touch control operation. For example, the user may use two fingers to slide on a touch panel to perform a zoom-in or zoom-out operation on a picture, and accurately locate the size of the zoomed-in picture or zoomed-out picture with two fingers.

In the prior art, a key technology of implementing multi-point touch control is a projected capacitive technology, and this technology includes a self capacitive type and a mutual capacitive type. The self capacitive type refers to that capacitance coupling is generated between a touch control object and an electrode, and a touch position is determined by measuring a change of the capacitance of the electrode. Main architecture of the mutual capacitive type is two conducting layers, when the screen is touched, capacitance coupling is generated between two adjacent layers of electrodes, one layer of the two conducting layers is a drive line, the other layer is an induction line, and the two lines are perpendicular to each other. In running, one drive line is driven in turn, whether capacitance coupling occurs on an induction line interlaced with this drive line is measured, and an accurate touch position is obtained through one by one scanning. If an X*Y matrix is used, the number of times of detection is X*Y theoretically.

During the implementation of embodiments of the present disclosure, the inventor finds that the single-touch control technology in the prior art has many limitations, and many operations cannot be implemented through single-point touch control, for example, zooming in or zooming out a picture according to a size required by a user and rotating the picture, so that a purpose of the user is difficult to be achieved by using the single-point touch control. As for the multi-point touch control technology in the prior art, the workload is large, a more powerful processor needs to be used, power consumption is high, and meanwhile, design complexity such as the design complexity of cabling is high. Therefore, the costs are high.

### SUMMARY

The present disclosure provides a touch control method and apparatus, so as to implement abundant touch control operations and reduce design complexity and costs.

An embodiment of the present disclosure provides a touch control method implemented in a touch control apparatus having a processor. The method includes: when the processor detects that a user triggers a function control, entering a function state corresponding to the function control. The processor detects a touch control operation performed by the user on an operation object on a touch control panel. Under the function state corresponding to the function control, the processor performs corresponding processing on the operation object according to the touch control operation of the user.

An embodiment of the present disclosure further provides a touch control apparatus. The apparatus includes a processor configured to control a touch control panel. The apparatus also includes: a first detection module, configured to enter a function state corresponding to the function control when the processor detects that a user triggers a function control; a second detection module, configured to detect a touch control operation performed by the user on an operation object on a touch control panel under the function state corresponding to the function control; and a processing module, configured to perform corresponding processing on the operation object according to the touch control operation of the user under the function state corresponding to the function control.

In embodiments of the present disclosure, the function state corresponding to the function control is entered by triggering the function control, and the touch control operation of the user is further detected. Under this function state, the corresponding processing is performed on the operation object according to the touch control operation of the user. This solution is capable of implementing more abundant touch control functions than single-point touch control and is easy to implement. Therefore, the design complexity of the touch control apparatus is able to be reduced.

### BRIEF DESCRIPTION OF THE DRAWINGS

To illustrate the solutions according to the embodiments of the present disclosure more clearly, the accompanying drawings for describing the embodiments are introduced briefly in the following. Apparently, the accompanying drawings in the following description are only some embodiments of the present disclosure, and persons of ordinary skill in the art can derive other accompanying drawings from these accompanying drawings without creative efforts.

FIG. 1 is a flow chart of a touch control method according to a first embodiment of the present disclosure;

FIG. 2a is a flow chart of a touch control method according to a second embodiment of the present disclosure;

FIG. 2b is a schematic diagram of a scenario of the touch control method according to the second embodiment of the present disclosure;

FIG. 3a is a flow chart of a touch control method according to a third embodiment of the present disclosure;

FIG. 3b is a schematic diagram of a scenario of the touch control method according to the third embodiment of the present disclosure;

FIG. 4a is a first schematic structural diagram of a touch control apparatus according to a fourth embodiment of the present disclosure;

FIG. 4b is a second schematic structural diagram of a touch control apparatus according to the fourth embodiment of the present disclosure; and

FIG. 4c is a third schematic structural diagram of a touch control apparatus according to the fourth embodiment of the present disclosure.

### DETAILED DESCRIPTION OF THE EMBODIMENTS

In order to make the objectives, solutions, and advantages of the present disclosure more comprehensible, the solutions according to embodiments of the present disclosure are clearly and completely described in the following with reference to the accompanying drawings. Apparently, the embodiments in the following description are merely a part rather than all of the embodiments of the present disclosure. All other embodiments obtained by persons of ordinary skill in the art based on the embodiments of the present disclosure without creative efforts shall fall within the protection scope of the present disclosure.

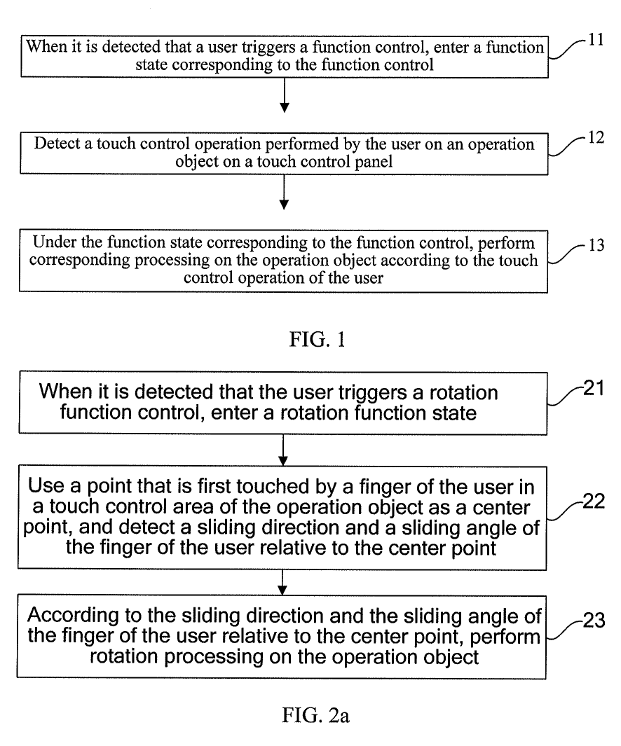

FIG. 1 is a flow chart of a touch control method according to a first embodiment of the present disclosure. The method includes the following steps:

Step 11: When it is detected that a user triggers a function control, enter a function state corresponding to the function control.

In this embodiment, various function controls are set on a touch control apparatus of the user, for example, a zoom function control and/or a rotation function control, and a function control may be a button on the touch control apparatus or a certain touch control area on a touch control panel. After the user clicks the button or touches an area of a function control on the touch control panel, a corresponding function state is entered. For example, if the user clicks a zoom button or touches an area of the zoom function control on the touch control panel, a zoom function state is entered, and it is determined that subsequent processing on an operation object (for example, a picture) is zoom processing; if the user clicks a rotation bottom or touches an area of the rotation function control on the touch control panel, a rotation function state is entered, and it is determined that the subsequent processing on the operation object is rotation processing.

Step 12: Detect a touch control operation performed by the user on the operation object on the touch control panel.

After the corresponding function state of the function control is entered, it is required to further detect a specific operation performed by the user on the operation object on the touch control panel. For example, under the rotation function state, it is required to further detect whether the user performs clockwise rotation or counterclockwise rotation on the touch control panel; under the zoom function state, it is required to further detect whether the user performs zoom-in processing or zoom out-processing on the operation object.

A method for detecting the touch control operation performed by the user on the touch control panel is illustrated in detail in the following embodiments with reference to specific application scenarios.

Step 13: Under the function state corresponding to the function control, perform corresponding processing on the operation object according to the touch control operation of the user.

After the corresponding function state of the function control is entered, and the touch control operation of the user is detected and determined, corresponding processing may be performed on the operation object. For example, under the rotation function state, if it is detected that the user performs a touch control operation of clockwise rotation, clockwise rotation is performed on the operation object.

In this embodiment, first, the function state corresponding to the function control is entered by triggering the function control, and then the touch control operation of the user is further detected. Under this function state, the corresponding processing is performed on the operation object according to the touch control operation of the user. This solution is capable of implementing more abundant touch control functions than single-point touch control and is easy to implement. Therefore, design complexity of the touch control apparatus is able to be reduced.

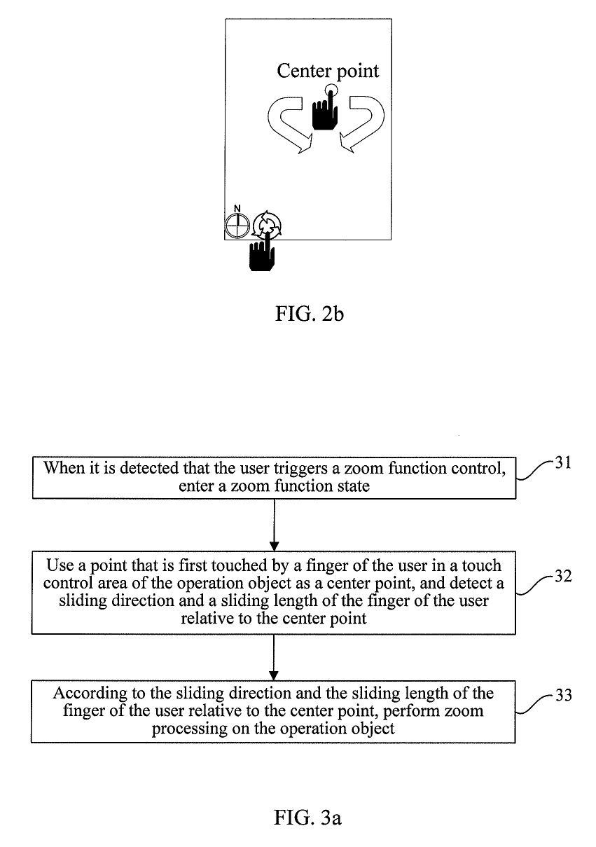

FIG. 2a is a flow chart of a touch control method according to a second embodiment of the present disclosure. In this embodiment, a user needs to perform a rotation operation on an operation object, for example, a certain picture, and the user may click a rotation function control to enter a rotation function state, so as to perform the rotation operation on the picture. The method includes the following steps:

Step 21: When it is detected that the user triggers the rotation function control, enter the rotation function state.

FIG. 2b is a schematic diagram of an application scenario of this embodiment. In FIG. 2b, the user first triggers the rotation function control, for example, clicks a rotation function button or touches a touch control area of the rotation function control. In this case, the rotation function state is entered. At this time, the user may use a finger to perform the rotation operation on the operation object on the touch control panel.

Step 22: Use a point that is first touched by the finger of the user in the touch control area of the operation object as a center point, and detect a sliding direction and a sliding angle of the finger of the user relative to the center point.

After the rotation function state is entered, it is required to further detect whether the finger of the user performs clockwise rotation or counterclockwise rotation, and an angle of the rotation. A detection method is as follows: using the point that is first touched by the finger of the user in the touch control area of the operation object as the center point, and detecting the sliding direction and the sliding angle of the finger of the user relative to the center point. If it is detected that the sliding direction of the finger of the user relative to the center point is a clockwise direction and the finger of the user slides 30 degrees clockwise, it is determined that the touch control operation of the user is rotating the operation object 30 degrees clockwise; if it is detected that the sliding direction of the finger of the user relative to the center point is a counterclockwise direction and the finger of the user slides 40 degrees counterclockwise, it is determined that the touch control operation of the user is rotating the operation object 40 degrees counterclockwise.

Step 23: According to the sliding direction and the sliding angle of the finger of the user relative to the center point, perform rotation processing on the operation object.

Under the rotation function state, according to the touch control operation of the user, corresponding processing is able to be performed on the operation object.

In this embodiment, two rotation function controls may also be set, that is, a clockwise rotation function control and a counterclockwise rotation function control. In this case, the sliding direction of the finger of the user does not need to be detected, and only the sliding angle of the finger of the user needs to be detected. For example, when the user clicks the clockwise rotation function control, in step 22, the corresponding alternative method is: using the point that is first touched by the finger of the user in the touch control area of the operation object as the center point, and detecting the sliding angle of the finger of the user relative to the center point; and in step 23, the corresponding alternative method is: according to the sliding angle of the finger of the user relative to the center point, performing the rotation processing on the operation object.

In this embodiment, first, the rotation function state is entered by triggering the rotation function control, and then the sliding direction and the sliding angle of the finger of the user on a touch control apparatus are further detected, so that abundant rotation touch control functions are implemented. In addition, this solution is easy to implement. Therefore, design complexity of the touch control apparatus is able to be reduced.

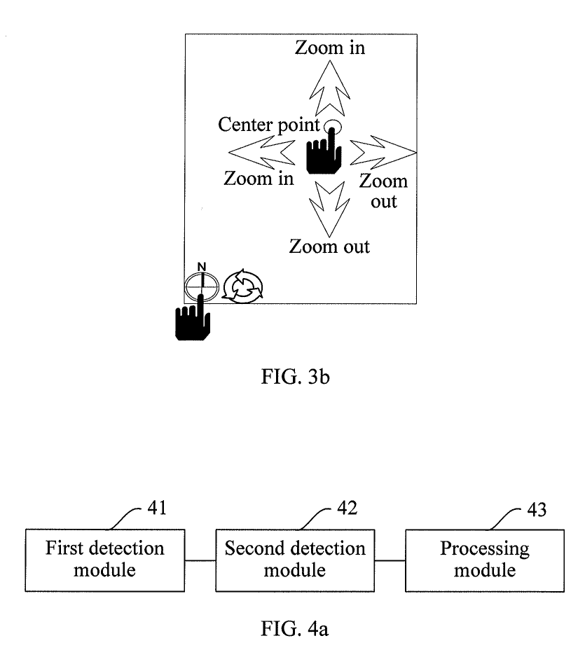

FIG. 3a is a flow chart of a touch control method according to a third embodiment of the present disclosure. In this embodiment, a user needs to perform a zoom operation on an operation object, for example, a certain picture, and the user may click a zoom function control to enter a zoom function state, so as to perform the zoom operation on the picture. The method includes the following steps:

Step 31: When it is detected that the user triggers the zoom function control, enter the zoom function state.

FIG. 3b is a schematic diagram of an application scenario of this embodiment. In FIG. 3b, the user first triggers the zoom function control, for example, clicks a zoom function button or touches a touch control area of the zoom function control. In this case, the zoom function state is entered. At this time, the user may use a finger to perform the zoom operation on the operation object on a touch control panel.

Step 32: Use a point that is first touched by the finger of the user in the touch control area of the operation object as a center point, and detect a sliding direction and a sliding length of the finger of the user relative to the center point.

After the zoomfunction state is entered, it is required to further detect whether the finger of the user slides in a first direction or slides in a second direction, and the sliding length. In this embodiment, the first direction represents a direction of zooming in the operation object, and the second direction represents a direction of zooming out the operation object. Customarily, the first direction may be an upward direction or a leftward direction, and the second direction may be a downward direction or a rightward direction.

A detection method is as follows: using the point that is first touched by the finger of the user in the touch control area of the operation object as the center point, and detecting the sliding direction and the sliding length of the finger of the user relative to the center point. If it is detected that the sliding direction of the finger of the user relative to the center point is the first direction, and the sliding length of the finger of the user is 20% of the length of the operation object, it is determined that the touch control operation of the user is zooming in the operation object by 20%; if it is detected that the sliding direction of the finger of the user relative to the center point is the second direction, and the sliding length of the finger of the user is 30% of the length of the operation object, it is determined that the touch control operation of the user is zooming out the operation object by 30%.

Step 33: According to the sliding direction and the sliding length of the finger of the user relative to the center point, perform zoom processing on the operation object.

Under the zoom function state, according to the touch control operation of the user, corresponding processing is able to be performed on the operation object.

In this embodiment, two function controls may also be set, that is, a zoom-in function control, and a zoom-out function control. In this case, the sliding direction of the finger of the user does not need to be detected, and only the sliding length of the finger of the user needs to be detected. For example, when the user clicks the zoom-in function control, in step 32, the corresponding alternative method is: using the point that is first touched by the finger of the user in the touch control area of the operation object as the center point, and detecting the sliding length of the finger of the user relative to the center point; and in step 33, the corresponding alternative method is: according to the sliding length of the finger of the user relative to the center point, performing zoom-in processing on the operation object.

In this embodiment, first, the zoom function state is entered by triggering the zoom function control, and then the sliding direction and the sliding length of the finger of the user on a touch control apparatus are further detected; so that abundant zoom touch control functions are implemented. In addition, this solution is easy to implement. Therefore, design complexity of the touch control apparatus is able to be reduced.

The foregoing illustrates implementing the rotation touch control function by setting the rotation function control and implementing the zoom touch control function by setting the zoom function control, separately. In the embodiments of the present disclosure, another function control may also be flexibly set and a corresponding touch control function may be implemented using the function control. The implementation principle is similar to that of the preceding methods, and therefore details are not described herein again.

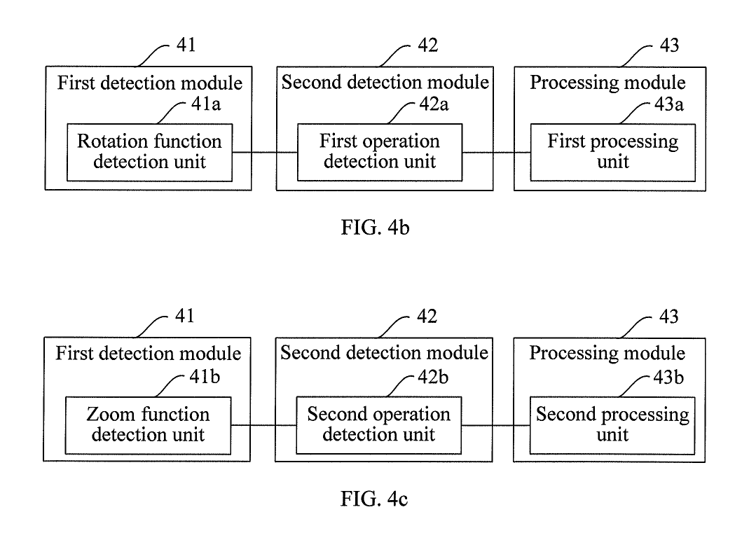

FIG. 4a is a first schematic structural diagram of a touch control apparatus according to a fourth embodiment of the present disclosure. The touch control apparatus includes: a first detection module 41, a second detection module 42 and a processing module 43.

The first detection module 41 is configured to, when it is detected that a user triggers a function control, enter a function state corresponding to the function control.

The second detection module 42 is configured to, under the function state corresponding to the function control, detect a touch control operation performed by the user on an operation object on a touch control panel.

The processing module 43 is configured to, under the function state corresponding to the function control, perform corresponding processing on the operation object according to the touch control operation of the user.

The function control is an entity control, for example, a keyboard button or a touch style control. The function control includes: a rotation function control and/or a zoom function control.

FIG. 4b is a second schematic structural diagram of a touch control apparatus according to the fourth embodiment of the present disclosure. In order to implement a rotation touch control function, the first detection module 41 includes: a rotation function detection unit 41a, configured to, when it is detected that the user triggers the rotation function control, enter a rotation function state.

The second detection module 42 includes: a first operation detection unit 42a, configured to, under the rotation function state, use a point that is first touched by a finger of the user in a touch control area of the operation object as a center point, and detect a sliding direction and a sliding angle of the finger of the user relative to the center point.

The processing module 43 includes: a first processing unit 43a, configured to, under the rotation function state, according to the sliding direction and the sliding angle of the finger of the user relative to the center point, perform rotation processing on the operation object.

FIG. 4c is a third schematic structural diagram of a touch control apparatus according to the fourth embodiment of the present disclosure. In order to implement a zoom touch control function, the first detection module 41 includes: a zoom function detection unit 41b, configured to, when it is detected that the user triggers the zoom function control, enter a zoom function state.

The second detection module 42 includes: a second operation detection unit 42b, configured to, under the zoom function state, use a point that is first touched by a finger of the user in a touch control area of the operation object as a center point, and detect a sliding direction and a sliding length of the finger of the user relative to the center point.

The processing module 43 includes: a second processing unit 43c, configured to, under the zoom function state, according to the sliding direction and the sliding length of the finger of the user relative to the center point, perform zoom processing on the operation object.

In this embodiment, first, the corresponding function state is entered by triggering the function control, and then the touch control operation of the user is further detected; and under this function state, the corresponding processing is performed on the operation object according to the touch control operation of the user. This solution is capable of implementing more abundant touch control functions than single-point touch control and is easy to implement. Therefore, design complexity of the touch control apparatus is able to be reduced.

It should be understood by persons of ordinary skill in the art that the accompanying drawings are merely schematic diagrams of embodiments, and modules or processes in the accompanying drawings are not indispensable for implementing the present disclosure.

It should be understood by persons of ordinary skill in the art that modules in an apparatus of an embodiment may be distributed in the apparatus of the embodiment according to the description of the embodiment, or correspondingly disposed in one or more apparatuses different from this embodiment after corresponding changes. The modules in the foregoing embodiment may be combined into one module or further divided into multiple sub-modules.

The sequence numbers of the foregoing embodiments of the present disclosure are merely for the convenience of description, and do not imply the preference among the embodiments.

Persons of ordinary skill in the art should understand that all or a part of the steps of the methods according to the embodiments may be implemented by a program instructing relevant hardware such as a processor coupled with a touch panel. The program may be stored in a computer readable storage medium accessible to the processor. When the program is run, the steps of the methods according to the embodiments are performed by the processor. The foregoing storage medium includes any medium that is capable of storing program codes, such as a ROM, a RAM, a magnetic disk or an optical disk.

Finally, it should be noted that the foregoing embodiments are merely provided for describing the solutions of the present disclosure, but not intended to limit the present disclosure. It should be understood by persons of ordinary skill in the art that although the present disclosure has been described in detail with reference to the foregoing embodiments, modifications can be made to the solutions described in the foregoing embodiments, or equivalent replacements can be made to some features in the solutions, as long as such modifications or replacements do not cause the essence of corresponding solutions to depart from the spirit and scope of the present disclosure.

What is claimed is:

1. A touch control method implemented in a touch control apparatus having a processor, comprising:
entering, a function state corresponding to the function control when the processor detects that a user triggers a function control;
detecting, by the processor, a touch control operation performed by the user on an operation object on a touch control panel; and
performing, by the processor, corresponding processing on the operation object according to the touch control operation of the user under the function state corresponding to the function control.

2. The touch control method according to claim 1, wherein the function control comprises at least one of the following: a rotation function control and a zoom function control.

3. The touch control method according to claim 2, wherein entering the function state corresponding to the function control when the processor detects that the user triggers the function control comprises:
entering a rotation function state when the processor detects that the user triggers the rotation function control;
correspondingly, detecting the touch control operation performed by the user on the operation object on the touch control panel comprises:
using a point that is first touched by a finger of the user in a touch control area of the operation object as a center point, and detecting a sliding direction and a sliding angle of the finger of the user relative to the center point; and
correspondingly, the performing the corresponding processing on the operation object according to the touch control operation of the user comprises:
according to the sliding direction and the sliding angle of the finger of the user relative to the center point, performing rotation processing on the operation object.

4. The touch control method according to claim 2, wherein entering the function state corresponding to the function control, when the processor detects that the user triggers the function control comprises:
entering a zoom function state when the processor detects that the user triggers the zoom function control;
correspondingly, detecting the touch control operation performed by the user on the operation object on the touch control panel comprises:
using a point that is first touched by a finger of the user in a touch control area of the operation object as a center point, and detecting a sliding direction and a sliding length of the finger of the user relative to the center point; and
correspondingly, the performing the corresponding processing on the operation object according to the touch control operation of the user comprises:
according to the sliding direction and the sliding length of the finger of the user relative to the center point, performing zoom processing on the operation object.

5. The touch control method according to claim 1 wherein the function control comprises one of the following: an entity control and a touch style control.

6. The touch control method according to claim 2, wherein the function control comprises one of the following: an entity control and a touch style control.

7. The touch control method according to claim 3, wherein the function control comprises one of the following: an entity control and a touch style control.

8. The touch control method according to claim 4, wherein the function control comprises one of the following: an entity control and a touch style control.

9. A touch control apparatus, comprising:
a processor configured to control a touch control panel;
a first detection module, configured to enter a function state corresponding to a function control when the processor detects that a user triggers the function control;
a second detection module, configured to detect a touch control operation performed by the user on an operation object on the touch control panel under the function state corresponding to the function control; and
a processing module, configured to perform corresponding processing on the operation object according to the touch control operation of the user under the function state corresponding to the function control.

10. The touch control apparatus according to claim 9, wherein the function control comprises at least one of the following: a rotation function control and a zoom function control.

11. The touch control apparatus according to claim 10, wherein
the first detection module comprises: a rotation function detection unit, configured to enter a rotation function state when the processor detects that the user triggers the rotation function control;
the second detection module comprises: a first operation detection unit, configured to use a point that is first touched by a finger of the user in a touch control area of the operation object as a center point, and detect a sliding direction and a sliding angle of the finger of the user relative to the center point under the rotation function state; and
the processing module comprises: a first processing unit, configured to according to the sliding direction and the sliding angle of the finger of the user relative to the center point, perform rotation processing on the operation object under the rotation function state.

12. The touch control apparatus according to claim 10, wherein
the first detection module comprises: a zoom function detection unit, configured to enter a zoom function state when the processor detects that the user triggers the zoom function control;
the second detection module comprises: a second operation detection unit, configured to use a point that is first touched by a finger of the user in the touch control area of the operation object as a center point, detect a sliding direction and a sliding length of the finger of the user relative to the center point under the zoom function state; and
the processing module comprises: a second processing unit, configured to according to the sliding direction and the sliding length of the finger of the user relative to the center point, perform zoom processing on the operation object under the zoom function state.

13. The touch control apparatus according to claim 9, wherein the function control comprises one of the following: an entity control and a touch style control.

14. The touch control apparatus according to claim 10, wherein the function control comprises one of the following: an entity control and a touch style control.

15. The touch control apparatus according to claim 11, wherein the function control comprises one of the following: an entity control and a touch style control.

16. The touch control apparatus according to claim 12, wherein the function control comprises one of the following: an entity control and a touch style control.
